(19) United States
(12) Patent Application Publication
(10) Pub. No.: US 2026/0186320 A1
(43) Pub. Date: Jul. 2, 2026

(54) 3D DISPLAY APPARATUS AND METHOD BASED ON LOW-COHERENCE LIGHT SOURCE

(71) Applicant: ELECTRONICS AND TELECOMMUNICATIONS RESEARCH INSTITUTE, Daejeon (KR)

(72) Inventor: Hyun-Eui KIM, Daejeon (KR)

(73) Assignee: ELECTRONICS AND TELECOMMUNICATIONS RESEARCH INSTITUTE, Daejeon (KR)

(21) Appl. No.: 19/434,893

(22) Filed: Dec. 29, 2025

(30) Foreign Application Priority Data
Dec. 27, 2024 (KR) 10-2024-0197943
Dec. 16, 2025 (KR) 10-2025-0200409

(51) Int. Cl. G02B 30/52

(52) U.S. Cl. CPC G02B 30/52

(57) ABSTRACT

Disclosed herein is a three-dimensional (3D) display apparatus and method based on a low-coherence light source. The 3D display apparatus based on a low-coherence light source may include a first modulation panel for generating and displaying two-dimensional (2D) amplitude information using a self-emissive low-coherence light source and a second modulation panel for converting the 2D amplitude information of the first modulation panel into voxels in a 3D space by modulating the 2D amplitude information into phase information.

### CROSS REFERENCE TO RELATED APPLICATIONS

This application claims the benefit of Korean Patent Applications No. 10-2024-0197943, filed Dec. 27, 2024, and No. 10-2025-0200409, filed Dec. 16, 2025, which are hereby incorporated by reference in their entireties into this application.

### BACKGROUND OF THE INVENTION

### 1. Technical Field

The disclosed embodiment relates to three-dimensional (3D) display technology.

### 2. Description of the Related Art

General 3D display technologies primarily rely on two-dimensional (2D) parallax information based on stereoscopic methods to visually convey a sense of depth. In contrast, holographic displays can effectively deliver 3D stereoscopic elements perceived by humans by reconstructing real images in a 3D space, so they are regarded as an ideal 3D display solution.

However, laser-based systems using highly coherent light sources are difficult to implement in practice due to issues, such as the characteristics of lasers that can be harmful to human vision, high cost, and complex system architecture.

Also, laser light sources generate speckle noise, which degrades image quality and restricts visual quality improvement.

In order to avoid these issues, 3D display technologies based on low-coherence or incoherent light sources, such as light-field or focus-stack methods, are considered, but these technologies have limitations in image quality and depth representation.

### SUMMARY OF THE INVENTION

An object of the disclosed embodiment is to solve eye-hazard and safety problems in conventional holographic displays using coherent laser light sources when implementing a 3D display.

Another object of the disclosed embodiment is to solve an image quality degradation problem caused by speckle noise resulting from laser interference when implementing a 3D display.

A further object of the disclosed embodiment is to solve the problems of high system cost and increased maintenance cost caused by the adoption of laser light sources and complex interferometer-based optical structures when implementing a 3D display.

Yet another object of the disclosed embodiment is to solve the problems of structural complexity and difficulties in miniaturization and lightweight design in conventional systems that require multiple optical elements and precise alignment processes when implementing a 3D display.

Still another object of the disclosed embodiment is to solve the problem where output resolution and image quality are limited due to a difference in resolution between first and second modulation panels and the aperture ratio limit of a Spatial Light Modulator (SLM) when implementing a 3D display.

Still another object of the disclosed embodiment is to solve the problems of insufficient depth representation range and stereoscopic reproduction capability in conventional technologies that rely on parallax information, such as stereoscopic methods or light-field methods, when implementing a 3D display.

Still another object of the disclosed embodiment is to solve a Direct Current (DC) noise problem where planar images are superimposed on 3D images due to DC component light generated by an SLM structure, resulting in degrading contrast, when implementing a 3D display.

A 3D display apparatus based on a low-coherence light source according to an embodiment may include a first modulation panel for generating and displaying 2D amplitude information using a self-emissive low-coherence light source and a second modulation panel for converting the 2D amplitude information of the first modulation panel into voxels in a 3D space by modulating the 2D amplitude information into phase information.

Here, the first modulation panel may be one of self-emissive low-coherence panels such as an OLED or an LCD.

Here, the second modulation panel may be a Spatial Light Modulator (SLM).

Here, 2D amplitude information of each pixel of the first modulation panel may be mapped to a macro pixel including N×N pixels of the second modulation panel and then be processed.

Here, the 3D display apparatus based on a low-coherence light source according to an embodiment may further include one or more polarization elements stacked in a light propagation direction in each of the first modulation panel and the second modulation panel.

Here, the 3D display apparatus based on a low-coherence light source according to an embodiment may further include an optical system for delivering 2D amplitude information output of the first modulation panel to the second modulation panel by using a lens.

Here, the optical system may enlarge or reduce the 2D amplitude information generated by the first modulation panel and deliver the enlarged or reduced 2D amplitude information to the second modulation panel.

Here, the second modulation panel may perform phase shifting such that the 2D amplitude information propagates at a predetermined off-axis angle.

Here, the second modulation panel may temporally adjust output positions of the voxels in the 3D space based on time-division and phase shifting and may display pixel information matching the shifted voxel output positions in synchronization with output of a phase-shift pattern.

A method for displaying a 3D image according to an embodiment may include generating 2D amplitude information using a self-emissive low-coherence light source and displaying the 2D amplitude information on a first modulation panel, delivering the 2D amplitude information output from the first modulation panel to a second modulation panel, and phase-modulating the 2D amplitude information in the second modulation panel to convert the 2D amplitude information into voxels in a 3D space.

Here, the first modulation panel may be one of self-emissive low-coherence panels such as an OLED or an LCD, and the second modulation panel may be a Spatial Light Modulator (SLM).

Here, the method for displaying a 3D image according to an embodiment may further include mapping 2D amplitude information of each pixel of the first modulation panel to a macro pixel including N×N pixels of the second modulation panel and processing the mapped 2D amplitude information.

Here, the method for displaying a 3D image according to an embodiment may further include controlling polarization by arranging one or more polarization elements along a light propagation direction of the first modulation panel and the second modulation panel.

Here, delivering the 2D amplitude information to the second modulation panel may include reimaging the 2D amplitude information of the first modulation panel using a relay optical system including one or more lenses.

Here, reimaging the 2D amplitude information may comprise enlarging or reducing the 2D amplitude information and delivering the enlarged or reduced 2D amplitude information to the second modulation panel.

Here, phase-modulating the 2D amplitude information in the second modulation panel may include applying a phase-shift pattern such that the 2D amplitude information propagates at a predetermined off-axis angle.

Here, phase-modulating the 2D amplitude information in the second modulation panel may include temporally adjusting output positions of the voxels in the 3D space based on time-division and phase shifting and displaying pixel information matching the shifted voxel output positions in synchronization with output of a phase-shift pattern.

A 3D display apparatus based on a low-coherence light source according to an embodiment includes a first modulation panel for generating and displaying 2D amplitude information using a self-emissive low-coherence light source, a second modulation panel for converting the 2D amplitude information of the first modulation panel into voxels in a 3D space by modulating the 2D amplitude information into phase information, and an optical system for enlarging or reducing 2D amplitude information output of the first modulation panel by using a lens and delivering the enlarged or reduced 2D amplitude information to the second modulation panel, and 2D amplitude information of each pixel of the first modulation panel may be mapped to a macro pixel including N×N pixels of the second modulation panel and then be processed.

Here, the second modulation panel may perform phase shifting such that the 2D amplitude information propagates at a predetermined off-axis angle.

Here, the second modulation panel may temporally adjust output positions of the voxels in the 3D space based on time-division and phase shifting and may display pixel information matching the shifted voxel output positions in synchronization with output of a phase-shift pattern.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a configuration diagram of a 3D display apparatus based on a low-coherence light source according to an embodiment;

FIG. 2 is an exemplary cross-sectional view of first and second modulation panels according to an embodiment;

FIG. 3 is an exemplary view for explaining a pixel-to-pixel mapping structure according to an embodiment;

FIGS. 4 and 5 are exemplary views of 3D image display of a 3D display apparatus based on a low-coherence light source according to an embodiment;

FIG. 6 is a configuration diagram of a 3D display apparatus based on a low-coherence light source according to another embodiment;

FIG. 7 is an exemplary cross-sectional view of a 3D image to which a time-division scheme is applied according to an embodiment;

FIG. 8 is a flowchart for explaining a 3D display method based on a low-coherence light source according to an embodiment; and

FIG. 9 is a view illustrating a computer system configuration according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

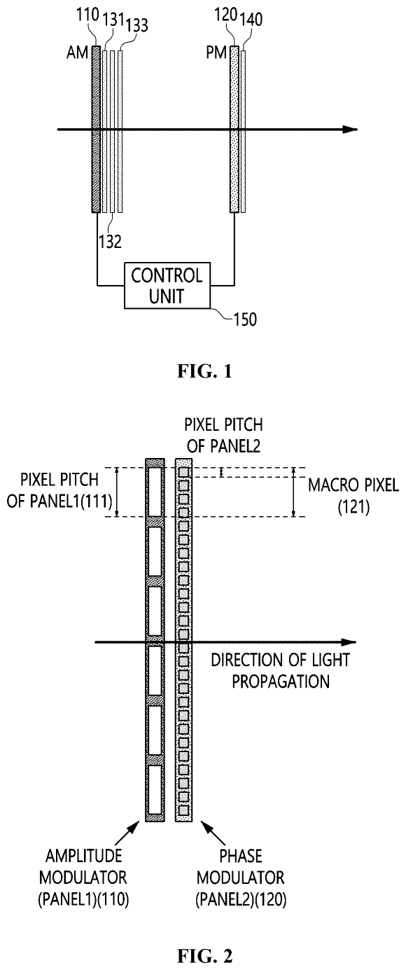

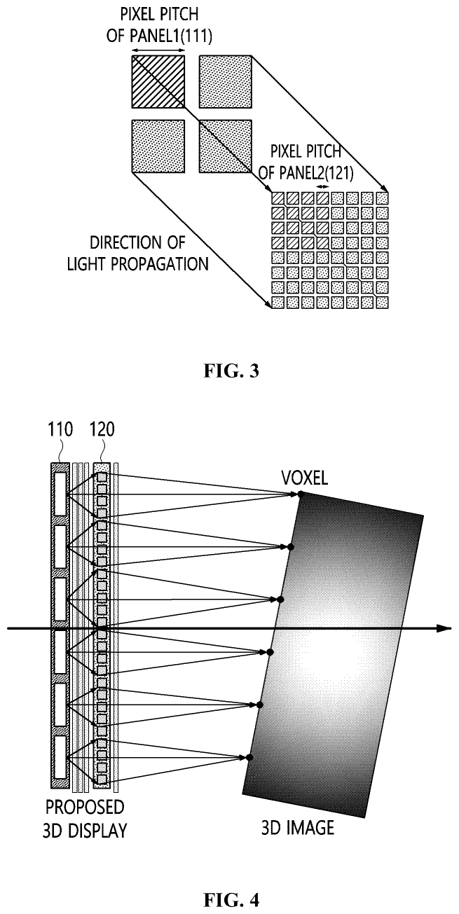

FIG. 1 is a configuration diagram of a 3D display apparatus based on a low-coherence light source according to an embodiment, FIG. 2 is an exemplary cross-sectional view of first and second modulation panels according to an embodiment, and FIG. 3 is an exemplary view for explaining a pixel-to-pixel mapping structure according to an embodiment.

Referring to FIG. 1, the 3D display apparatus based on a low-coherence light source according to an embodiment may include a first modulation panel 110 and a second modulation panel 120.

The first modulation panel 110 may be an amplitude modulation (AM) panel that generates and displays 2D amplitude information using a self-emissive low-coherence light source.

Here, the first modulation panel 110 represents the intensity information of color channels, and may be implemented as one of panels that use a self-emissive or quasi-emissive low-coherence light source, such as an OLED, a micro-LED, or an LCD including a backlight.

Unlike conventional hologram reconstruction methods that require coherent laser light sources, the structure based on a low-coherence light source does not generate speckle noise and offers the advantage of greatly improving system safety and usability by eliminating expensive or high-risk laser light sources.

The second modulation panel 120 may be a phase modulation (PM) panel that converts the 2D amplitude information of the first modulation panel 110 into voxels in a 3D space by modulating the 2D amplitude information into phase information. That is, it receives light waves containing 2D amplitude information from the first modulation panel 110 and adjusts the phase of the light waves to form voxels in the 3D space.

Here, the second modulation panel 120 may be implemented as a Spatial Light Modulator (SLM).

Also, the 3D display apparatus based on a low-coherence light source according to an embodiment may further include one or more polarization elements 131, 132, 133, and 140 that are stacked in a light propagation direction in each of the first modulation panel 110 and the second modulation panel 120.

Here, the polarization elements 131, 132, 133, and 140 perform the following functions.

The Quarter Wave Plate (QWP) 131 may convert linearly polarized light into circularly polarized light or convert circularly polarized light into linearly polarized light.

The Half Wave Plate (HWP) 132 rotates the direction of linear polarization to a desired angle. This may be used to align the polarization axis between the first modulation panel 110 and the second modulation panel 120.

The Linear Polarizers (LPs) 133 and 140 align unpolarized or arbitrarily polarized light into a single linear polarization component. This is for satisfying the characteristic of the SLM that exhibits an optimal phase response in a specific polarization state.

Accordingly, the polarization elements provide functions that enable the two panels to independently perform amplitude modulation and phase modulation, and may be selectively combined to match the operating polarization conditions of the two panels.

Also, although the components are illustrated as being spaced apart from each other in FIG. 1, the actual optical structure may be configured such that all components are physically adjacent or bonded to each other in order to improve optical efficiency and reduce external disturbances.

Meanwhile, the 3D display apparatus based on a low-coherence light source according to an embodiment may further include a control unit 150 for controlling the operations of the first modulation panel 110 and the second modulation panel 120. Such a control unit 150 synchronizes the pixel control signals of the first modulation panel 110 and the second modulation panel 120 and separately controls the amplitude pattern and the phase pattern such that 2D amplitude information is combined with an accurate phase pattern and is converted into a 3D voxel structure.

Here, referring to FIGS. 2 and 3, the 2D amplitude information of each of pixels 111 of the first modulation panel 110 may be mapped to a macro pixel 121 including N×N pixels (N being a natural number) of the second modulation panel 120 and then be processed.

That is, the resolution of the second modulation panel 120 is higher than that of the first modulation panel 110, so it is possible to secure multiple phase control pixels corresponding to each amplitude pixel and to generate a more precise 3D wavefront.

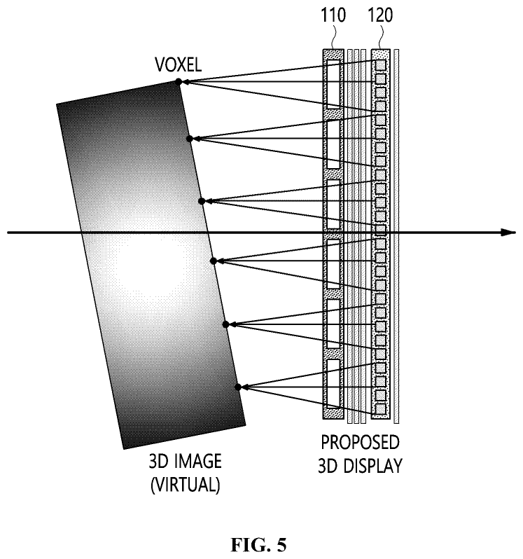

FIGS. 4 and 5 are exemplary views of 3D image display of a 3D display apparatus based on a low-coherence light source according to an embodiment.

FIG. 4 shows the case in which the 3D image is generated in the positive depth direction relative to the panel plane, and FIG. 5 shows the case in which the 3D image is generated in the negative depth direction relative to the panel plane.

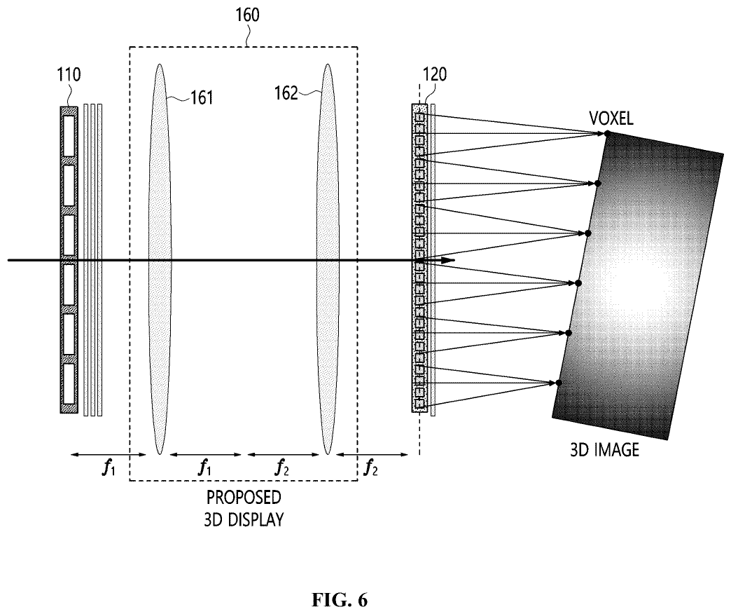

FIG. 6 is a configuration diagram of a 3D display apparatus based on a low-coherence light source according to another embodiment.

Referring to FIG. 6, the 3D display apparatus based on a low-coherence light source according to another embodiment may further include an optical system 160 for delivering the 2D amplitude information of the first modulation panel 110 to the second modulation panel 120, in addition to the configuration of the 3D display apparatus illustrated in FIG. 1.

Here, the optical system 160 functions to enlarge or reduce the 2D amplitude information of the first modulation panel 110 and reimage it onto the second modulation panel 120, and may include lenses 161 and 162.

For example, when the size of a pixel 111 of the first modulation panel 110 does not match that of a corresponding macro pixel 121 of the second modulation panel, the optical system 160 may perform enlargement or reduction to match the sizes of the two pixels.

For delivery, the following two types of structures may be used.

The first type is a method of uniformly enlarging or reducing the entire panel area and delivering the same to the second modulation panel 120, and this may be implemented by applying three relay optical structures proposed in the existing “3D optical microscope device of small form factor optical system (Korean Patent Application Publication No. KR 2023-0065892)”.

The second type is a method of dividing the panel area into multiple subregions and applying an individual relay optical system to each subregion, and this may be implemented by applying the structure disclosed in “Hologram display Apparatus and Method thereof” (Korean Patent Application Publication No. KR 2019-0080808)”.

Here, any one of the three optical structures proposed in “3D optical microscope device of small form factor optical system (Korean Patent Application Publication No. KR 2023-0065892)” may be selected and applied to the relay optical system used in each subregion.

Meanwhile, in the macro pixel of the second modulation panel 120, in order to converge the light wave to a target voxel position, a phase lens function corresponding to an arbitrary focal length f as shown in Equation (1) is displayed to phase-modulate the input light wave.

$$U ( x , y ) = exp ( j \frac{π}{λ f} ( {x}^{2} + {y}^{2} ) ) \qquad ( 1 )$$

In Equation (1), 1 denotes a wavelength, f denotes a focal length, and (x, y) denotes the spatial coordinates in the SLM.

Accordingly, each pixel of the first modulation panel 110 may be represented as a 3D point cloud that forms multiple voxels in the 3D space.

However, this method has some limitations.

First, when an SLM is used as the second modulation panel 120, optical noise may occur. That is, because the aperture ratio of the SLM is not 100%, unmodulated light waves passing through the panel generate DC noise corresponding to a direct current component. As a result, the observer may view a planar DC noise image superimposed on the intended 3D image.

Therefore, the second modulation panel 120 may perform phase shifting such that the 2D amplitude information propagates at a predetermined off-axis (tilted) angle in the lateral direction.

That is, by multiplying the lens function U (x, y) of Equation (1) by the off-axis phase-shift function of Equation (2) below, the 3D image is spatially separated from the DC component, thereby minimizing mutual interference within the field of view of the observer.

$${U}_{tilt} ( x , y ) = exp ( j \frac{2 π}{λ} ( x sin {θ}_{x} + y sin {θ}_{y} ) ) \qquad ( 2 )$$

Meanwhile, because the pixel resolution of the first modulation panel 110 is set relatively lower than that of the second modulation panel 120, there may be a limitation in the output resolution that can be displayed.

Accordingly, the second modulation panel 120 according to an embodiment may temporally adjust the output positions of voxels in a 3D space based on time-division and phase shifting and display pixel information matching the shifted pixel output positions in synchronization with the phase-shift pattern.

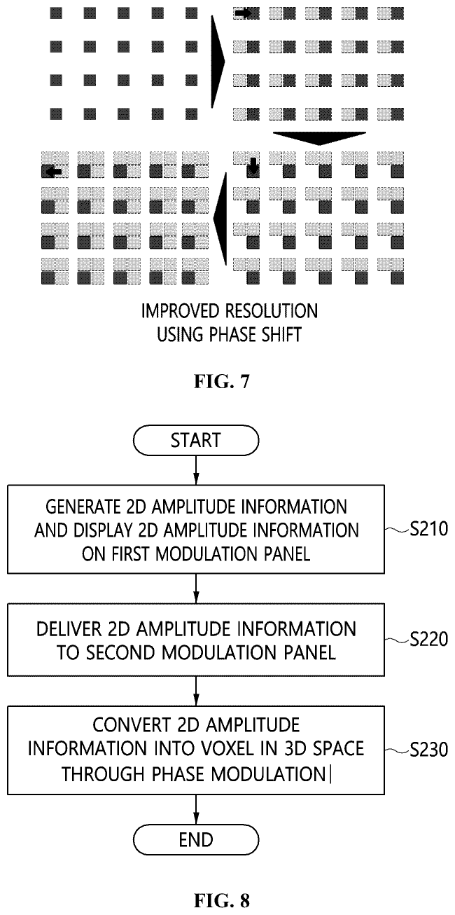

FIG. 7 is an exemplary cross-sectional view of a 3D image to which a time-division scheme is applied according to an embodiment.

Referring to FIG. 7, without additionally increasing the resolution of the second modulation panel 120, the phase modulation pattern displayed on the SLM of the second modulation panel 120 is finely adjusted through the above-described phase shift function, whereby the output light wave is formed at a position physically shifted by approximately one pixel from the previously output voxel position.

By applying the time-division method, adjacent pixel information corresponding to the new physical position phase-shifted from the previous display position on the time axis is sequentially displayed in synchronization with the output of the phase-shift pattern, whereby a high-resolution image that exceeds the resolution limit of the first modulation panel may be generated.

FIG. 8 is a flowchart for explaining a 3D display method based on a low-coherence light source according to an embodiment.

Referring to FIG. 8, the 3D image display method according to an embodiment may include generating 2D amplitude information using a self-emissive low-coherence light source and displaying the same on a first modulation panel at step S210, delivering the 2D amplitude information output from the first modulation panel to a second modulation panel at step S220, and converting the 2D amplitude information into voxels in a 3D space by phase-modulating the 2D amplitude information in the second modulation panel at step S230.

Here, the first modulation panel may be one of self-emissive low-coherence panels such as an OLED or an LCD, and the second modulation panel may be a Spatial Light Modulator (SLM).

Here, the 3D image display method according to an embodiment may further include mapping 2D amplitude information of each pixel of the first modulation panel to a macro pixel including N×N pixels of the second modulation panel and processing the mapped 2D amplitude information.

Here, the 3D image display method according to an embodiment may further include controlling polarization by arranging one or more polarization elements along the light propagation directions of the first and second modulation panels.

Here, delivering the 2D amplitude information to the second modulation panel at step S220 may include reimaging the 2D amplitude information of the first modulation panel using a relay optical system including one or more lenses.

Here, reimaging the 2D amplitude information may comprise enlarging or reducing the 2D amplitude information and delivering the same to the second modulation panel.

Here, phase-modulating the 2D amplitude information in the second modulation panel at step S230 may include applying a phase-shift pattern such that the 2D amplitude information propagates at a predetermined off-axis angle.

Here, phase-modulating the 2D amplitude information in the second modulation panel at step S230 may include temporally adjusting the output positions of the voxels in the 3D space based on time-division and phase shifting and displaying pixel information matching the shifted voxel output positions in synchronization with the output of the phase-shift pattern.

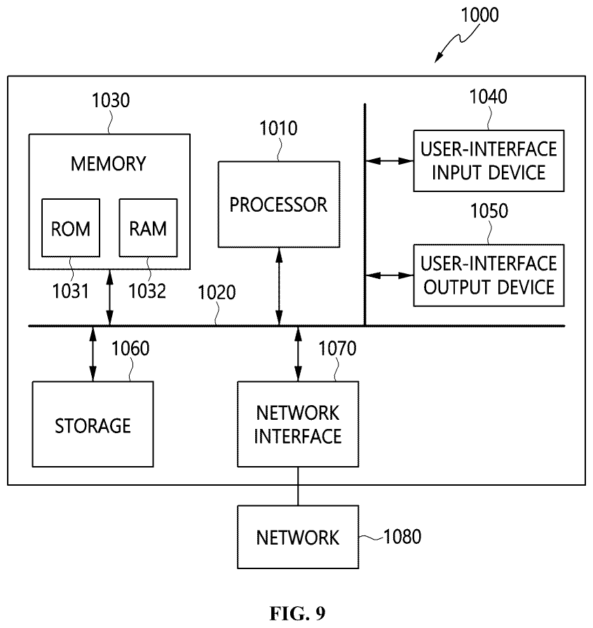

FIG. 9 is a view illustrating a computer system configuration according to an embodiment.

The control unit 150 of the 3D display apparatus based on a low-coherence light source according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the disclosed embodiment, when implementing a 3D display, a self-emissive low-coherence panel is used as an amplitude modulation panel, whereby eye hazard and safety problems caused by coherent laser light sources may be solved.

According to the disclosed embodiment, when implementing a 3D display, a visual image quality degradation problem caused by speckle noise generation may be solved by using an incoherent light source instead of a light source based on laser interference.

According to the disclosed embodiment, when implementing a 3D display, a high-cost problem of existing systems that use a complex-interferometer-based optical structure may be solved by separating amplitude modulation and phase modulation into two independent panels.

According to the disclosed embodiment, when implementing a 3D display, only the minimum number of polarization elements required for an independent panel structure are stacked, whereby a structural complexity problem of conventional systems that require multiple optical elements and precise alignment may be solved.

According to the disclosed embodiment, when implementing a 3D display, an output position shifting technique based on time-division and phase shifting is applied, whereby limitations in output image quality and spatial resolution caused by a difference in resolution between first and second modulation panels may be solved.

According to the disclosed embodiment, when implementing a 3D display, an off-axis phase-shift function is multiplied by a lens function to propagate a light wave in a specific lateral direction, whereby superposition of DC component light and a DC noise problem caused by the aperture-ratio limit of an SLM may be solved.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. A three-dimensional (3D) display apparatus based on a low-coherence light source, comprising:
a first modulation panel for generating and displaying two-dimensional (2D) amplitude information using a self-emissive low-coherence light source; and
a second modulation panel for converting the 2D amplitude information of the first modulation panel into voxels in a 3D space by modulating the 2D amplitude information into phase information.

2. The 3D display apparatus of claim 1, wherein the first modulation panel is one of self-emissive low-coherence panels such as an OLED or an LCD.

3. The 3D display apparatus of claim 1, wherein the second modulation panel is a Spatial Light Modulator (SLM).

4. The 3D display apparatus of claim 1, wherein 2D amplitude information of each pixel of the first modulation panel is mapped to a macro pixel including N×N pixels of the second modulation panel and is then processed.

5. The 3D display apparatus of claim 1, further comprising:
one or more polarization elements stacked in a light propagation direction in each of the first modulation panel and the second modulation panel.

6. The 3D display apparatus of claim 1, further comprising:
an optical system for delivering 2D amplitude information output of the first modulation panel to the second modulation panel by using a lens.

7. The 3D display apparatus of claim 6, wherein the optical system enlarges or reduces the 2D amplitude information generated by the first modulation panel and delivers the enlarged or reduced 2D amplitude information to the second modulation panel.

8. The 3D display apparatus of claim 1, wherein the second modulation panel performs phase shifting such that the 2D amplitude information propagates at a predetermined off-axis angle.

9. The 3D display apparatus of claim 1, wherein the second modulation panel temporally adjusts output positions of the voxels in the 3D space based on time-division and phase shifting and displays pixel information matching the shifted voxel output positions in synchronization with output of a phase-shift pattern.

10. A method for displaying a three-dimensional (3D) image, comprising:
generating two-dimensional (2D) amplitude information using a self-emissive low-coherence light source and displaying the 2D amplitude information on a first modulation panel;
delivering the 2D amplitude information output from the first modulation panel to a second modulation panel; and
phase-modulating the 2D amplitude information in the second modulation panel, thereby converting the 2D amplitude information into voxels in a 3D space.

11. The method of claim 10, wherein
the first modulation panel is one of self-emissive low-coherence panels such as an OLED or an LCD, and
the second modulation panel is a Spatial Light Modulator (SLM).

12. The method of claim 10, further comprising:
mapping 2D amplitude information of each pixel of the first modulation panel to a macro pixel including N×N pixels of the second modulation panel and processing the mapped 2D amplitude information.

13. The method of claim 10, further comprising:
controlling polarization by arranging one or more polarization elements along a light propagation direction of the first modulation panel and the second modulation panel.

14. The method of claim 10, wherein delivering the 2D amplitude information to the second modulation panel comprises reimaging the 2D amplitude information of the first modulation panel using a relay optical system including one or more lenses.

15. The method of claim 14, wherein reimaging the 2D amplitude information comprises enlarging or reducing the 2D amplitude information and delivering the enlarged or reduced 2D amplitude information to the second modulation panel.

16. The method of claim 14, wherein phase-modulating the 2D amplitude information in the second modulation panel comprises applying a phase-shift pattern such that the 2D amplitude information propagates at a predetermined off-axis angle.

17. The method of claim 10, wherein phase-modulating the 2D amplitude information in the second modulation panel comprises temporally adjusting output positions of the voxels in the 3D space based on time-division and phase shifting and displaying pixel information matching the shifted voxel output positions in synchronization with output of a phase-shift pattern.

18. A three-dimensional (3D) display apparatus based on a low-coherence light source, comprising:
a first modulation panel for generating and displaying two-dimensional (2D) amplitude information using a self-emissive low-coherence light source;
a second modulation panel for converting the 2D amplitude information of the first modulation panel into voxels in a 3D space by modulating the 2D amplitude information into phase information; and
an optical system for enlarging or reducing 2D amplitude information output of the first modulation panel using a lens and delivering the enlarged or reduced 2D amplitude information to the second modulation panel,
wherein 2D amplitude information of each pixel of the first modulation panel is mapped to a macro pixel including N×N pixels of the second modulation panel and is then processed.

19. The 3D display apparatus of claim 18, wherein the second modulation panel performs phase shifting such that the 2D amplitude information propagates at a predetermined off-axis angle.

20. The 3D display apparatus of claim 18, wherein the second modulation panel temporally adjusts output positions of the voxels in the 3D space based on time-division and phase shifting and displays pixel information matching the shifted voxel output positions in synchronization with output of a phase-shift pattern.
